(19) United States
(12) Patent Application Publication
(10) Pub. No.: US 2012/0273340 A1
(43) Pub. Date: Nov. 1, 2012

(54) METHOD & APPARATUS FOR SANITIZING AIR IN AIRCRAFT, COMMERCIAL AIRLINERS, MILITARY VEHICLES, SUBMARINES, SPACE CRAFT, CRUISE SHIPS , PASSENGER VEHICLES, MASS TRANSIT AND MOTOR VEHICLES BY INTEGRATION OF HIGH DENSITY HIGH EFFICIENCY ULTRA VIOLET ILLUMINATION APPARATUS WITHIN AIR CONDITIONING, VENTILATION AND TEMPERATURE CONTROL SYSTEMS

(76) Inventor: Perry Felix, Houston, TX (US)

(21) Appl. No.: 12/963,627

(22) Filed: Dec. 8, 2010

(51) Int. Cl. B01D 53/74; B01J 19/08

(52) U.S. Cl. 204/157.3; 96/224

(57) ABSTRACT

The present invention provides a method and apparatus for sanitizing air within a ventilation system using ultraviolet light. The air is exposed to the ultraviolet light for a preselected duration of time and at a desired power level to achieve a desired level of sanitization.

### BACKGROUND OF THE INVENTION

1. Field of the Invention

This invention relates generally to sanitizing air within terrestrial and extraterrestrial vehicles or ships as engaged in the transportation of passengers and includes all forms of mass transit or public transportation in addition to passenger or motor vehicles, aircraft, spacecrafts, cruise ships & ocean liners, submarines, armored cars or military vehicles and includes commercial passenger jets, passenger trains, buses, trucks, cars and all motor vehicles and more specifically as applied for the sterilization and sanitizing of passenger air as required to kill all airborne viruses, germs, mold, fungi and bacteria suspended within the air by use of compact, high efficiency integrated ultra violet (UV) lighting methods and apparatus which is adapted to air control systems and which utilizes new high efficiency UV illumination sources including Vertical Cavity Surface Emitting UV Lasers, UV Light Emitting Diodes (UV-LEDs), UV phosphor and UV plasma.

2. Description of the Related Art

In the course of day-to-day activities, people come into contact with various viruses, germs, mold, bacteria and fungi. After exposure to viruses, bacteria and germs, many people become ill and also become contagious hosts that carry these viruses, bacteria or germs with them as they travel by various methods including mass transit or public transportation as well as private transportation methods such as passenger vehicles. In using private, mass transit or public transportation methods, these hosts then share common areas and air space with other travelers or passengers who become exposed to the illness from the hosts that may cough or sneeze or exhale in the common air space which suspends germs in the common air space. The germs, viruses and bacteria that are suspended in particles are then carried through air flow into the collective passenger areas which in turn infects and spreads more germs, viruses or bacteria into the common air space. As people are exposed to the germs, bacteria or flu viruses in confined, re-circulating or controlled air spaces, they continue to spread and propagate the germs, bacteria and viruses resulting in more infections and a more rapid spread of the illnesses or and potentially life threatening diseases. As advanced flu or virus strains become more resistant to treatment, there are increasing risks and increasing global health concerns for potentially devastating epidemics. The rapid and accelerated spread of new diseases that are increasingly resistant to common antibiotics or that require greater quantities of vaccines to immunize a rapidly growing population support an ever increasing need for safer travel solutions and for methods to lessen or reduce exposure to all infectious diseases including everything from the common cold or to reduce exposure to higher concentrations of the latest generation of deadly viruses and bacteria. The increased strain on vaccination research, production and distribution add to the logistical complexities in keeping our world safe.

Heating, Ventilation, and Air Conditioning (HVAC) systems are routinely employed in homes, offices, commercial buildings, mass transit vehicles, personal vehicles, and the like. Generally, these systems are responsible for maintaining the comfort of the passengers/inhabitants located therein by maintaining a desired temperature, air quality, and even humidity in some cases. The HVAC systems accomplish temperature control by heating and cooling the air contained therein to the desired temperature, and then circulating the temperature controlled air throughout the vehicle/building via a fan or blower system.

Typically, these HVAC systems re-circulate at least a portion of the air contained within the vehicle/building, and in some cases, may draw only a small amount of air from exterior to the vehicle/building. This recirculation of air within the system can lead to problems. For example, germs or viruses introduced into one limited area of the system may be circulated throughout the entire vehicle/building by the HVAC system. Thus, a sick and infected person on an aircraft or bus may expose a large number of passengers to airborn viruses and/or bacteria via the re-circulated air in the HVAC system.

Similarly, the ductwork of an HVAC system can become contaminated with mold, mildew, spores, or other undesirable contaminants. The forced air circulation within the HVAC system may be responsible for distributing these undesirable items throughout the vehicle/building, thereby exposing the passengers/inhabitants to a variety of undesirable contaminants that may cause allergic reactions and other health related issues.

Recently infected hosts or people that carry germs, viruses or bacteria may or may not show outward signs of having an illness but may still be contagious and may actively spread the disease without knowing. Therefore, proactive and preventive measures or solutions are a good defense against the spread of a devastating epidemic. In addition to germs, viruses and bacteria, mold, fungi and numerous allergens can be greatly reduced if not eliminated, ensuring passenger comfort by controlling if not preventing physical discomfort from sinus related irritations and illness.

Exposures of this type continue to increase the strain on global health and foster an environment where dangerous onsets of deadly illness the foundation for deadly global epidemics. These germs, viruses, bacteria, etc. are then added to naturally occurring pollen, and re-distributed throughout passenger areas in commercial or private jets, within buses and passenger trains or within confined spaces in ocean liners, submarines or areas in mass transit vehicles or passenger or mass transit vehicles, which then exposes other travelers to these germs, viruses or bacteria. The propagation of these viruses, bacteria or germs continues as more people are exposed and more people share in the common air space.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for sanitizing air in a ventilation system by exposing the air to ultraviolet light.

In another embodiment, a method is provided for casting or molding (VCSEL) Vertical Cavity Surface Emitting Lasers or (UVLED) Ultra Violet Light Emitting Diodes, with expansion or collimating lenses, into a ventilation tube or pipe section, that is of a similar compact size as the original tube, as produced with a transparent or translucent substrate or casing with a high density, high output UV light energy from the Vertical Cavity Surface Emitting Lasers or UV LEDs focused or projected inward, with a reflective exterior coating on the pipe section to concentrate UV light energy internally. As indicated above, the UV Phosphor or UV Plasma could then be used as a substitute light source and applied in a thin luminous layer which is cast within or applied to the surface or laminated to the inner circumference verses the Vertical Cavity Surface Emitting UV Laser or Surface Mount UV LEDs providing an economical alternative however the air flow rate or capacity supported may subsequently be reduced due to the small size and reduced UV light energy output however the ventilation tubing containing the UV lasers could be produced in a smaller more compact size similar to the original ventilation tube. In another embodiment, the UV Lasers, LEDs, Phosphor or Plasma can be produced in a tube like lamp with UV light energy projected inward with dimensions sufficient to allow the UV sanitizing apparatus to slide inside an air vent, hose or fan housing with minimal air flow interference or wind drag that can be quickly and easily replaced and formed or produced in a variety of shapes and sizes. Both the UV vent segment or internal sleeve could then be connected to a regulated power supply or power source by a signal & power cable which would then be controlled by an internal sensor to detect and monitor the UV energy output level. If the UV output were to drop below a defined level, the power would be increased to balance the relative UV energy or to reduce the energy and output as required to ensure a consistent sanitizing process.

### BRIEF DESCRIPTION OF THE DRAWINGS

The disclosed subject matter may be understood by reference to the following description taken in conjunction with the accompanying drawings, in which like reference numerals identify like elements, and in which:

FIGS. 1 thru 11 conceptually illustrate various embodiments of the instant invention.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present invention provides a safe, economical, efficient and effective method and apparatus for sanitizing air in mass transit, military, commercial or private passenger vehicles using Vertical Cavity Surface Emitting Lasers Ultra Violet Lasers, Ultra Violet LEDs or UltraViolet Phosphor or Plasma to kill bacteria, viruses, germs, mold, fungi and various allergens. The UV sanitizing apparatus can be easily and economically produced and adapted to a broad variety of vehicles including space crafts, cruise ships, submarines, buses, trains, jets and passenger vehicles and the control system can regulate, monitor and adjust the output levels to ensure effective sanitation for the most healthful benefits in controlling the spread of the new generation of deadly viruses.

The sanitizing solution and apparatus described herein may be integrated into all forms of commercial transportation, military vehicles and passenger vehicles. The systems and apparatus may be installed within air conditioning, temperature control or environmental control systems by adapting an internal UV illumination core to existing air circulation systems or by replacing existing air flow conduit or air vent segments and fittings with UV vent segments and fittings or UV tube, pipe or hose segments that are engineered and produced to match and mate to original vent fittings with minimal conversion or obstruction to air pathways. UV illuminated replacement valve or air vent sections may be produced by casting acrylic or injection molding of translucent plastic polymer or similar material typically in a cylindrical pipe design with an internal grid of UV LEDs, or (VCSEL) Vertical Cavity Surface Emitting Lasers in a plurality and alternately a UV plasma or UV phospher film may be cast or applied to an interior vent circumference. A mirrored coating is applied to the exterior to reflect UV light internally as combined with UV LEDs or UV Laser Arrays formed by UV SLED Surface Emitting Light Emitting Diodes or by casting of clear acrylics that contain VCSEL Vertical Cavity Surface Emitting Lasers with Micro Lens Arrays or by affixing, attaching, forming or casting vent sections using UV light emitting materials or phosphor applied within the ventilation chambers or vent tubing so as to minimize obstruction or alteration of air pathways, thus avoiding disruption or thereby to avoid reducing the impedance of air flow and to subsequently support the adaptation into both new and pre-existing air conditioning or temperature & environmental control systems.

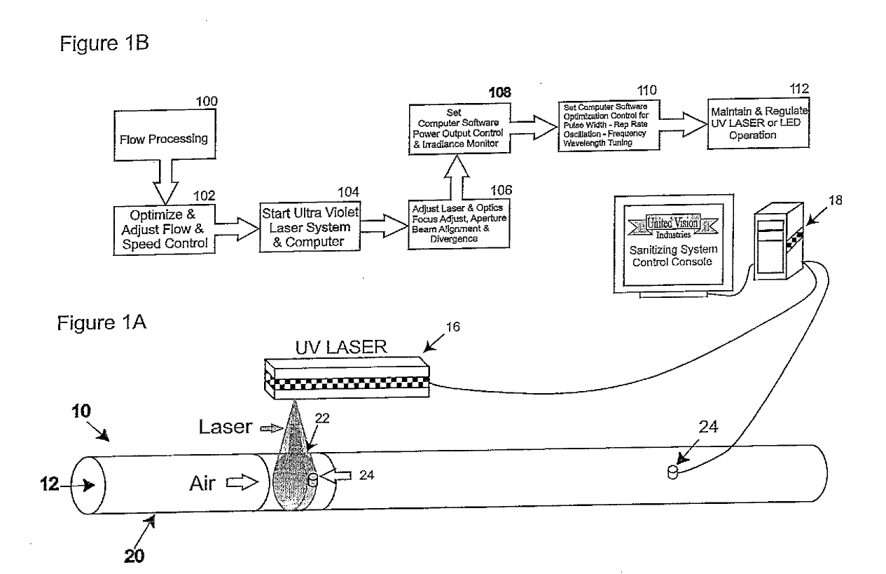

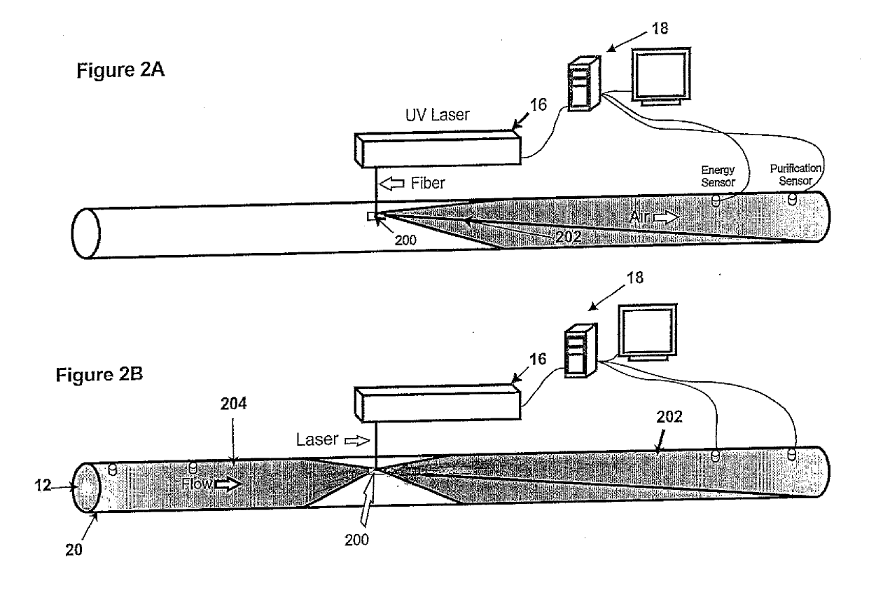

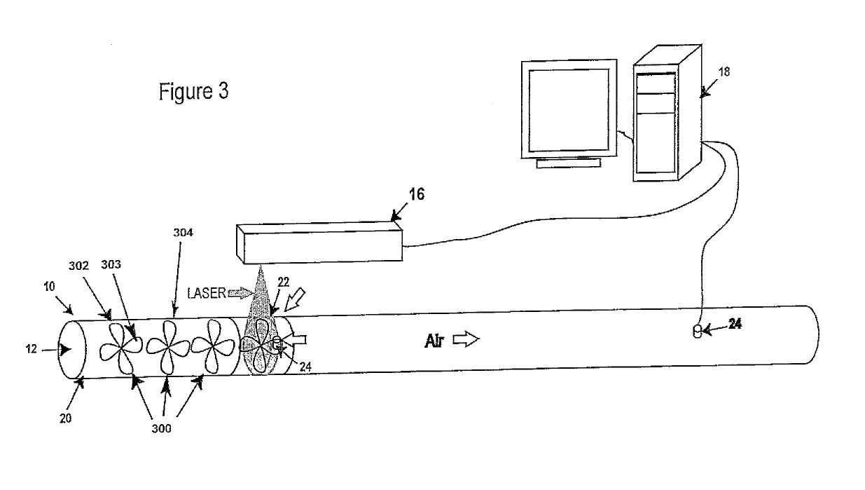

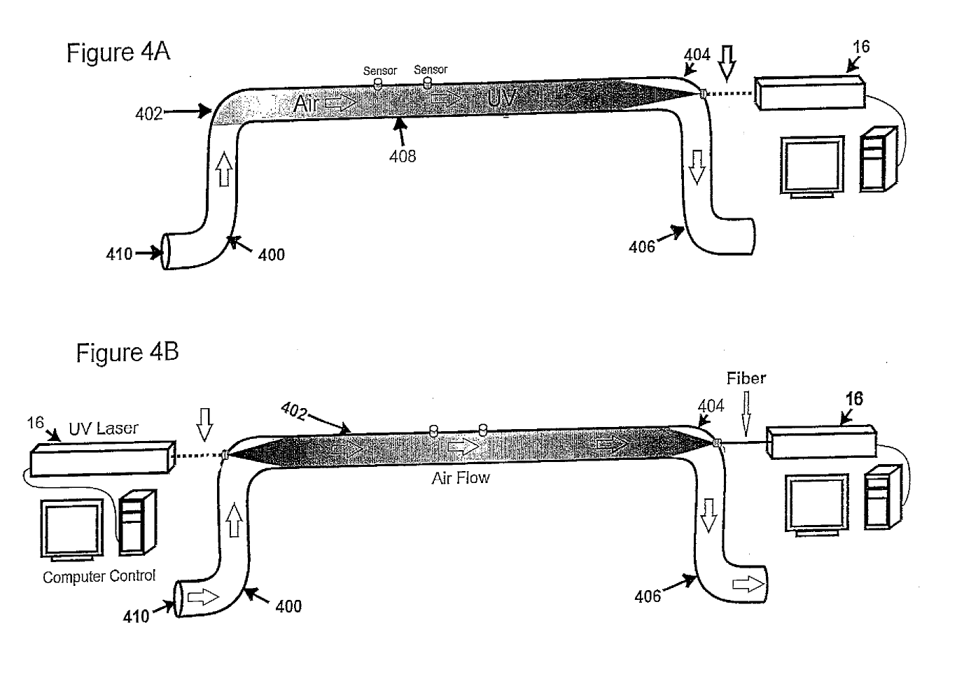

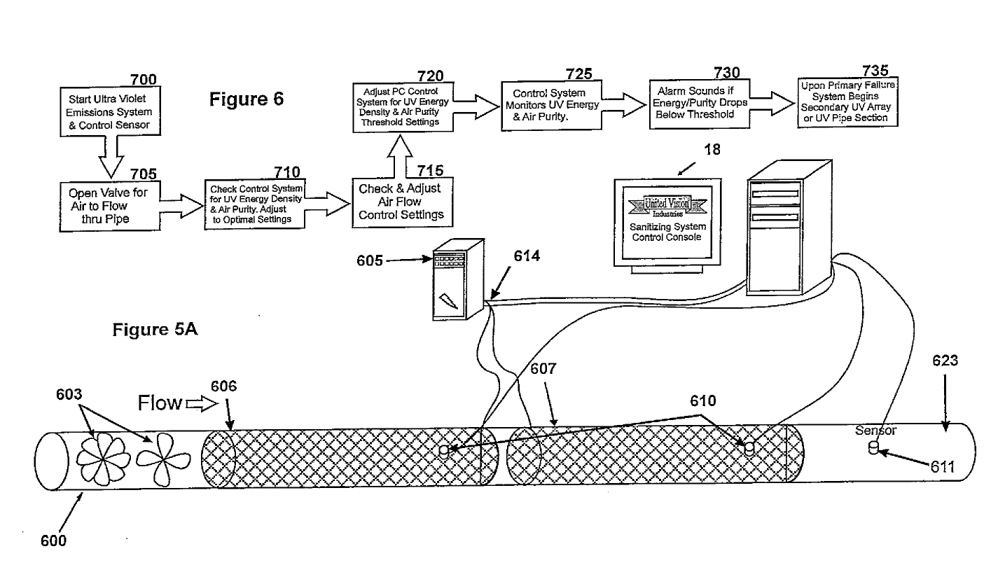

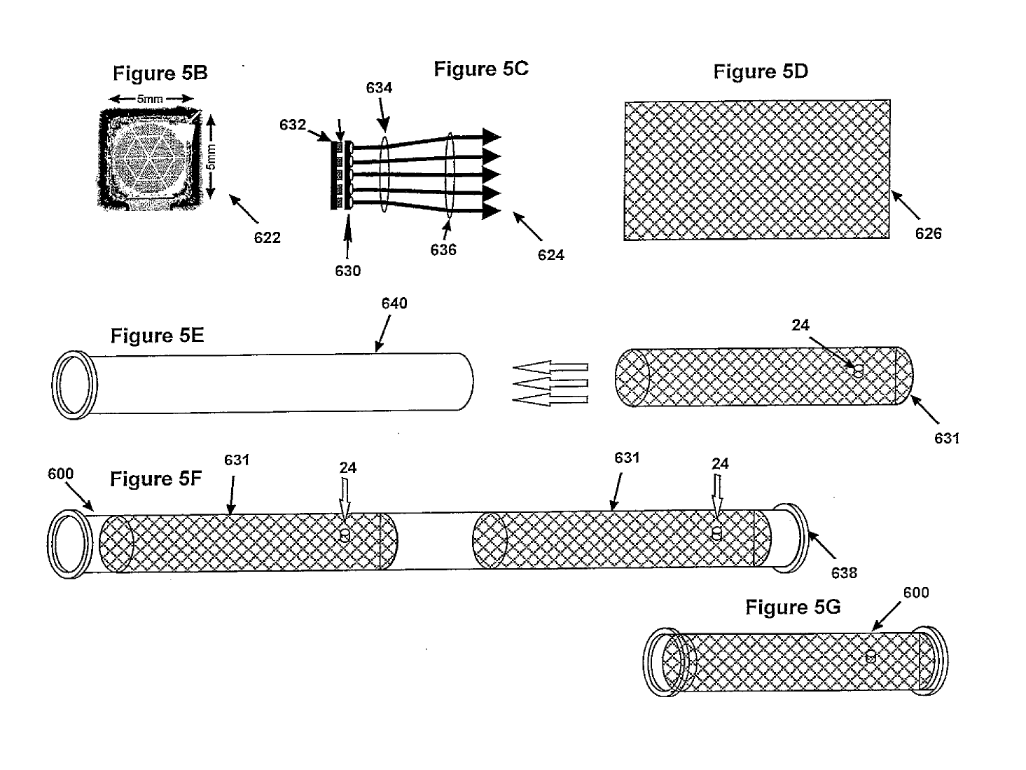

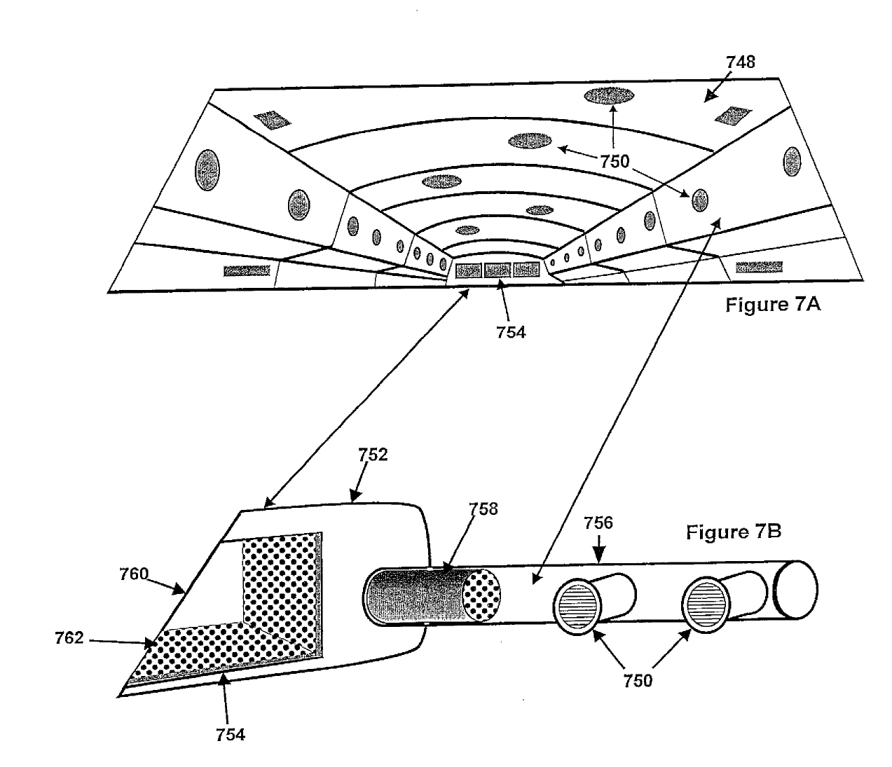

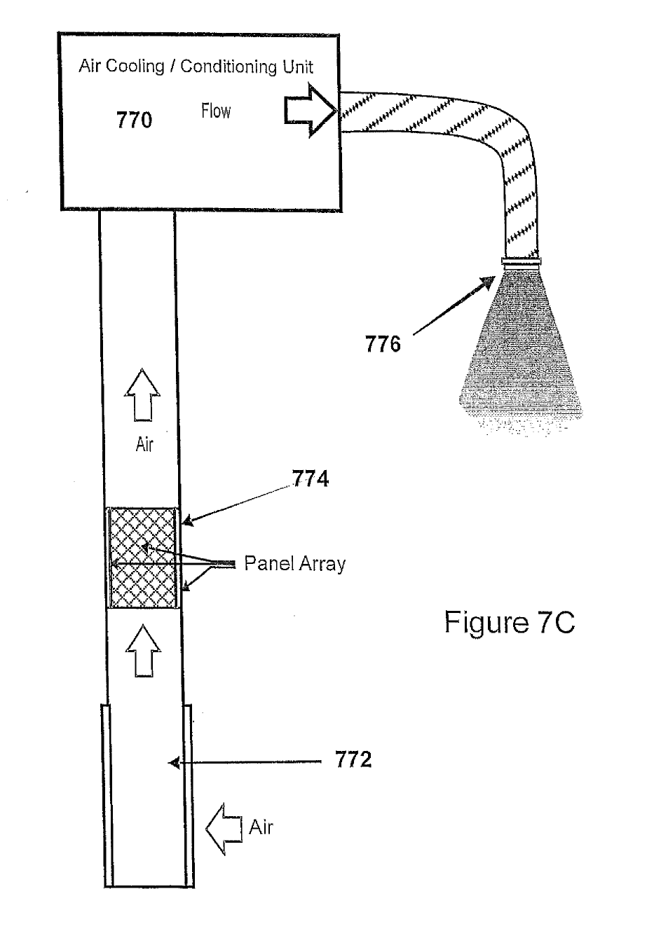

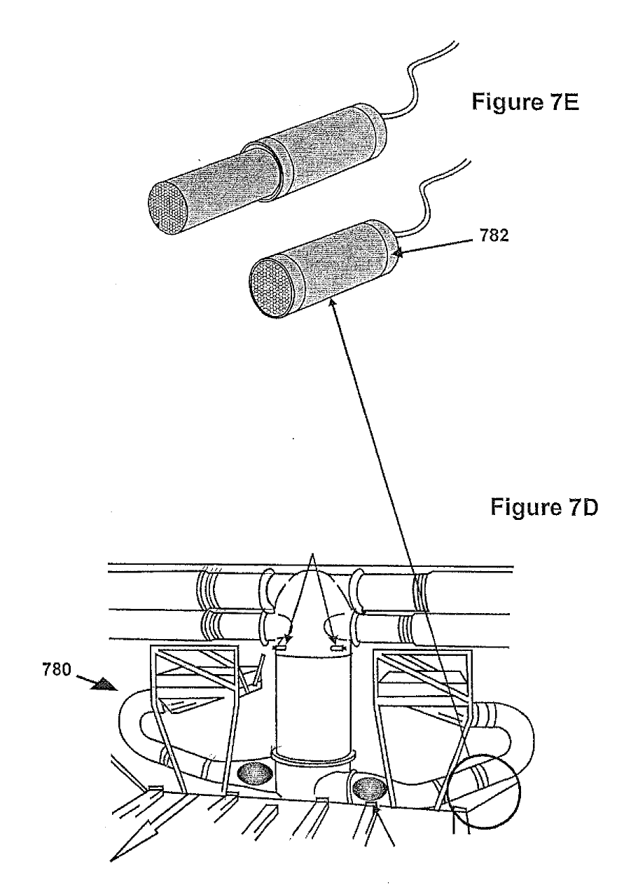

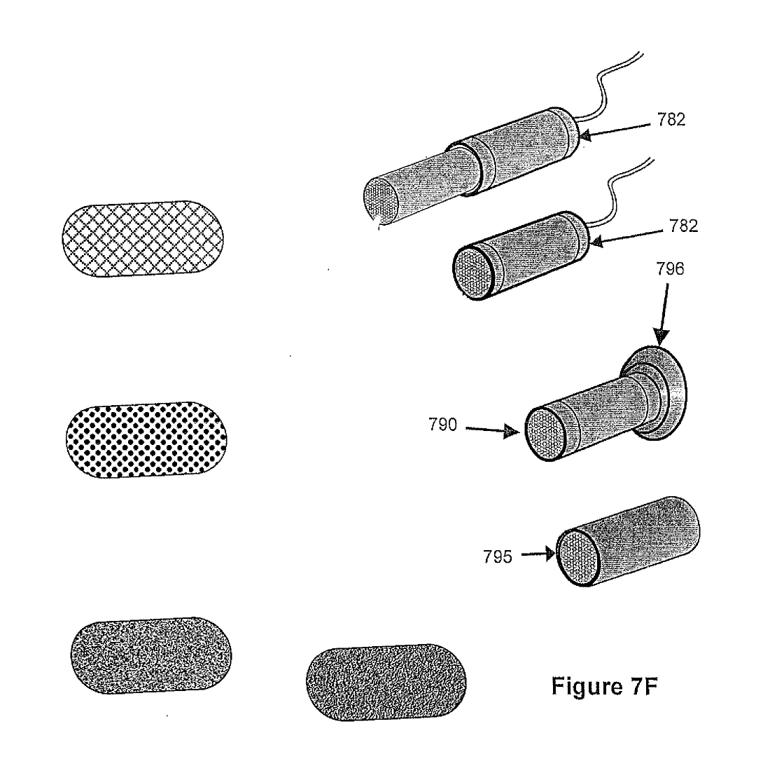

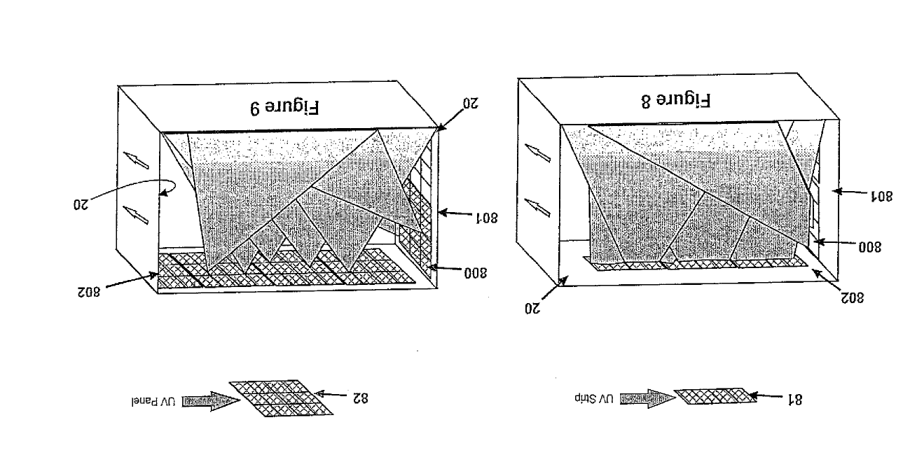

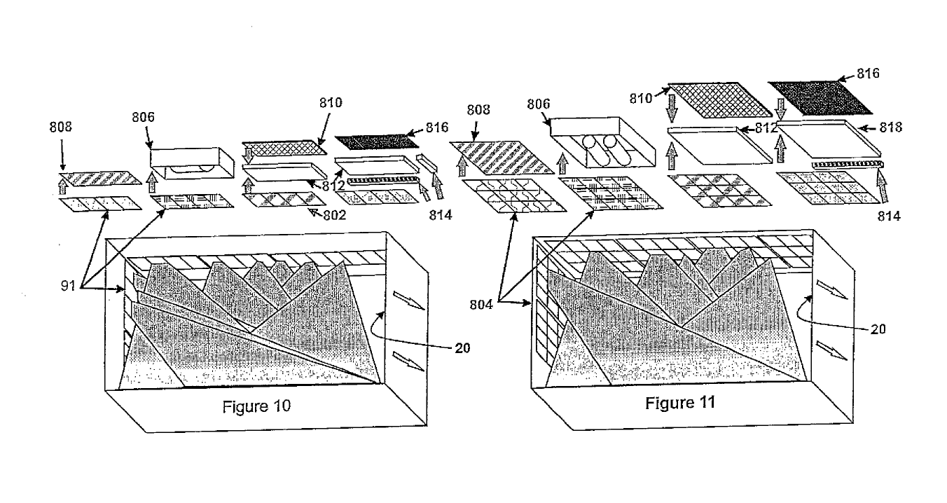

FIG. 1A conceptually illustrates a first exemplary embodiment of the instant invention. Generally, a system 10 is provided to sanitize air 12 while the air is being distributed throughout a vehicle/building. The system 10 includes an ultraviolet (UV) light source 16, such as a UV laser, operating under the control of a computer control system 18 to expose air flowing through ductwork 20 of an HVAC system to UV light.

The UV light source 16 may take on any of a variety of forms, but generally, a common wavelength for the UV light source 16, when used in a sanitizing application, is in the range of about 266 nm to about 355 nm, which those skilled in the art will appreciate includes near UV wavelengths of about 220 nm to about 400 nm, far UV wavelengths of about 190 nm to about 220 nm, and VAC UV wavelengths of about 90 nm to about 190 nm. Depending on the area of coverage and/or size of the container, conduit, pipe or ductwork, and flow rate, the power of the UV light source 16 may range from as little as a 2 mW UV laser to hundreds or even thousands of watts of UV laser power. In one exemplary embodiment of the instant invention, a UV laser 16 operating at about 355 nm wavelength proved to be highly effective in sanitizing contaminated water to achieve an effective purity rate as high as 99.7% for killing bacteria, viruses, mold, fungi and insect larvae. In one particular embodiment, the UV laser may take the form of Model No. DP-UV-355 available from Han's Laser and may be comprised of an array of one or more lasers.

The UV light may be distributed within the ductwork 20 using a variety of mechanical and/or optical systems. For example, a rotating or oscillating mirror may be used to reflect the UV light through a port 22 in the pipe 20 to create a pattern of light that effectively exposes the air 12 to the UV light regardless of the location of the air 12 within the ductwork 20. FIG. 1A illustrates the UV light being distributed in a circular pattern for illustrative purposes only. Those skilled in the art will appreciate that the UV light could be distributed in a variety of patterns, such as square, rectangular, linear, raster scan or even random patterns in order to effectively expose the air 12 to the UV light.

It is anticipated that some embodiments of the invention may utilize a plurality of UV light sources 16, such as UV lasers. Moreover, when multiple UV light sources 16 are employed, they may be selected to have substantially similar or substantially different wavelengths. In some embodiments, it may be useful to provide two or more UV light sources 16 irradiating the air 12 at substantially the same location with substantially similar wavelengths to achieve higher power levels. Alternatively, in some embodiments, it may be useful to provide two or more UV light sources 16 irradiating the air 12 at different, spaced-apart locations to achieve greater coverage. Further, some embodiments of the instant invention may utilize two or more UV light sources 16 that operate at different wavelengths to expose the air 12 to a wider range of UV light in cases where the various contaminants are eradicated more effectively by different frequencies of UV light.

The computer control system 18 may take on any of a variety of forms, including but not limited to conventional desktop computers, laptop computers, servers, minicomputers, controllers, and the like. The computer control system 18 may be comprised of a microprocessor, memory, a display, and input or pointing devices, such mice, keyboards, touch sensitive pads or screens and the like.

In one embodiment of the instant invention, the computer control system 18 operates to control various parameters of the system 10 to insure an effective kill rate. For example, a UV power sensor 24 may be disposed to sense the actual level of UV power being delivered to the air 12 in the ductwork 20. The UV power sensor 24 provides feedback to the computer control system 18. The computer control system 18 may then vary a signal delivered to the light source 16 to raise or lower the power of the UV light source 16, as desired. Additionally, the flow rate of the air 12 in the ductwork 20 may likewise be adjusted according to the actual UV power detected by the UV power sensor 24. For example, the computer control system 18 may reduce the flow rate of the air 12 in response to detecting reduced UV power, and/or control upstream processes to affect air parameters, such as turbidity, etc. For example, the computer control 18 system may send a signal to an upstream process that is designed to clarify the air 12. Those skilled in the art will appreciate that clear air will more readily pass the UV light than will more turbid air. Those skilled in the art will appreciate that UV power may be increased throughout the ductwork 20 by increasing air clarity.

FIG. 1B illustrates an exemplary embodiment of a control sequence that may be implemented, at least partially, within the computer control system 18. The process begins at block 100 with airflow being provided through the ductwork 20. At block 102, the computer control system 18 selects or establishes a desired flow rate of the air 12. At block 104, the UV laser 16 is enabled, and various parameters of the UV laser 16 are adjusted, either manually, or by the computer control system 18 at block 106. For example, it may be useful to set the laser and optics focus adjustment, aperture beam alignment, and divergence. At block 108, the computer control system 18 sets the laser output power based on feedback of digital signals received from the irradiance monitor, which detects concentrations of UV laser energy levels and provides continuous feedback of UV energy relayed to the logic control of the computer to maintain stable and effective levels of laser power 16 required for safe purification and sanitization of the air. Periodically, the computer control system 18 will receive a control signal from the laser power sensor 24, and use that signal to adjust various parameters of the UV laser 16 to achieve the desired sanitization of the air 12. For example, at block 110 the computer control system 18 may set or adjust a pulse width, a repetition rate, and/or tune the frequency wavelength of the UV laser 16. These parameters may be adjusted as necessary to maintain a desired level of UV laser power in the ductwork 20.

It may also be useful to periodically test the air 12 to determine the effectiveness of the sanitizing process. Thus, at block 112, the results of this testing may be input into the computer control system 18 and used to further control the sanitizing process. For example, if the testing indicates an undesirable level of contamination in the sanitized air 12, then the computer control system 18 may further adjust the parameters of the system to produce a greater level of sanitization, such as by reducing the flow rate of the air 12, increasing the power of the UV laser 16 and/or increasing the clarity of the air 12.

Additionally or alternatively, it may be useful to route the air 12 through one or more additional sanitizing steps, depending upon the results of the testing. For example, inadequately sanitized air 12 may be passed through the same UV sanitizing process, or alternatively through a second similarly arranged system 10.

In various alternative embodiments of the instant invention, it may be useful to provide a plurality of paths for the UV light to traverse from one or more UV light sources 16 to the air 12. In this manner, a more complete exposure of the air 12 to the UV light may be accomplished. For example, various laser light paths may be accomplished by routing the laser light through flexible fiber optic links or through other conventional optical devices, such as mirrors, splitters, and the like, to pass through multiple ports 24 distributed at various locations longitudinally along the pipe or at various locations distributed about the periphery of the pipe 20.

Alternatively, turning first to FIG. 2A, the UV light source 16 projects light through one or more optical devices 200, such as fiber optic cables, beam splitters, mirrors, or the like, to produce one or more beams of UV light 202 extending along a line generally longitudinally aligned with the ductwork 20 in either an upstream or downstream direction. These beams of UV light 202 may be configured by the optical devices 200 to diverge and flood the ductwork 20 with UV laser light along the length of the ductwork 20. In one embodiment of the instant invention, it may be useful to form at least a portion of the interior of the ductwork 20 be coated with or formed from a reflective or refractive material to cause the UV light to reflect or bend back toward the interior of the ductwork 20 and thereby provide greater coverage of the interior of the ductwork 20 with the UV light.

FIG. 2B illustrates an alternative embodiments of the instant invention in which multiple UV light paths are presented within the ductwork 20. In the illustrated embodiment of the instant invention, at least a portion of the UV light is passed in both an upstream and downstream direction within the ductwork 20. The optical devices 200 may be arranged to produce one or more beams of UV light 202, 204 extending along a line generally longitudinally aligned with the ductwork 20 in both the upstream and downstream directions. These beams of UV light 202, 204 may be configured by the optical devices 200 to diverge or expand and flood the ductwork 20 with UV light along the length of the pipe 20. In this manner, water 12 may be more thoroughly exposed to the sanitizing effect of the UV laser as focused coherent UV laser beams provide light energy and power at sufficient concentration and density at great depths to effectively illuminate and sanitize the air and therefore completely eliminates the need for using hazardous chemicals in large volume systems. The UV sanitizing systems shown in many flexible designs are easily implemented and adopted to a wide variety of existing air treatment systems to efficiently and effectively irradiate and eradicate impurities without further need or use of chemicals treatments.

In various alternative embodiments of the instant invention, it may be useful to disturb the air 12 and any contaminates contained therein to insure that the contaminants within the air 12 are thoroughly exposed to the UV light. Turning now to FIG. 3, a first embodiment of a system that disturbs the air 12 in the ductwork 20 is described. In the illustrated embodiment, the ductwork 20 includes a mechanism 300 for creating turbulence in the air within the ductwork 20. In this manner, contaminants within the air 12 become reoriented, exposing previously hidden surfaces to the UV light and enhancing the sanitizing effect of the UV light. The turbulence creating mechanism 300 may take on any of a variety of forms, such as devices that adjust the flow rate of the air 12, alter the path of the air 12, and the like. In one embodiment of the instant invention, a fan or propeller structure 302 may be positioned within the ductwork 20. The propeller 302 may be freewheeling, and thus, it is turned by the force of the air flowing therethrough, or it may be driven to induce a stirring action in the air 12. In some embodiments of the instant invention, it may be useful to employ a plurality of propellers 302. In embodiments of the instant invention that employ either single or plural propellers 302 mounted or contained within the ductwork 20, it may be useful to utilize propellers 302 constructed of highly polished stainless steel 303 or other materials having a highly reflective or coated finish. Likewise, the interior surface of the pipe 20 may also be made from or coated with similarly highly reflective materials to provide reflective interior surfaces 304. In this manner, UV light directed to the propellers 302 may be reflected therefrom, thereby increasing angles of incidence of the UV light beams within the ductwork 20 and improving overall pervasiveness of UV light irradiation for more effective air sanitization.

Turning now to FIGS. 4A and 4B, alternative embodiments of the instant invention are shown. FIGS. 4A and 4B illustrate alternative embodiments of the instant invention in which air is sanitized by UV light that is transmitted substantially along the direction of flow of the air within the ductwork 20. In the illustrated embodiments, the ductwork 20 is modified to include a plurality of curved or bent sections 400, 402, 404, 406 to produce a linear region 408 that is offset from the main path 410 of the ductwork 20. This arrangement allows the UV light to be readily introduced into the linear region 408 by optically coupling the UV light source 16 at the curved sections 402, 404. This configuration allows the UV light beam to be introduced along a line generally longitudinally aligned with the ductwork 20 in either the upstream direction (as shown in FIG. 4A) or both the upstream and downstream directions (as shown in FIG. 4B). These beams of UV light 202 may be configured by the optical devices 200 to diverge and flood the linear region 408 of the ductwork 20 with UV light along a substantial portion of the length of the ductwork 20.

Those skilled in the art will appreciate that the curved sections 400, 402, 404, 406 may advantageously introduce turbulence into the air 12 within the linear region 408 of the ductwork 20. As discussed previously, this turbulence produces a mixing effect that may further disturb the contaminants so that they are more thoroughly exposed to the UV light to produce a greater sanitizing effect.

An alternative embodiment of the instant invention is shown in FIGS. 5A-5G and FIG. 6. Generally, the embodiment illustrated herein is comprised of a pipe 600 formed from a material that allows UV light to pass therethrough. In some embodiments of the instant invention at least an interior region of the pipe 600 may be formed from translucent, transparent, or otherwise optically neutral material. UV light sources 606 are disposed adjacent or within this interior region and arranged to project UV light into an interior chamber of the pipe 600, through which air to be sterilized is flowing. In one particular embodiment, the pipe 600 may be formed or cast from acrylic, glass, or other translucent or transparent material with one or more grids or matrices of UV light sources 606 located therein. It is envisioned that hundreds, or even thousands, of the light sources 606 may be disposed therein to provide sufficient UV light to effectively sanitize the air flowing through the pipe 600. The UV light sources 606 may take on any of a variety of forms, such as UV Vertical Light Emitting Diodes (“VLEDs”), Vertical Cavity Surface Emitting Lasers (“VCSELs”), UV Edge Emitting Lasers (“EELs”), UV plasma devices, or UV phosphor devices.

A power source 605 is electrically coupled to the UV light sources 606. The computer control system 18 is coupled to the power source 605, and operates to modify or control the amount of power delivered to the UV light sources 606 to provide a desired level of sanitization for the air flowing through the pipe 600. In some embodiments of the instant invention, it may be useful to provide feedback sensors 610, 611 to ensure that a desired level of sanitization is being accomplished. The feedback sensor 610 may take the form of a UV energy sensor, which provides a feedback signal to the computer control system 18 indicating the amount of energy being delivered from the UV light sources 606. The computer control system 18 uses the feedback signal to controllably adjust the power source 605 to increase or decrease the power delivered to the UV light sources 606 to match the measured (actual) energy with the energy desired by the computer control system 18.

Additionally or alternatively, the feedback sensor 611 may take the form of a air purification sensor. The air purification sensor 611 can provide a feedback signal to the computer control system 18, which the computer control system 18 may use to adjust the energy being delivered from the UV light sources 606. In the event that the air purification sensor 611 indicates that the purity of the air falls below a preselected setpoint, then the computer control system 18 may increase the power being delivered from the power source 605 to increase the energy supplied by the UV light sources 606 and provide an additional sanitizing affect. Alternatively, if the air purification sensor 611 indicates that the purity of the air is above a preselected setpoint, then the computer control system 18 may reduce the power being delivered from the power source 605 to provide a reduced sanitizing affect.

In some embodiments of the instant invention, it may be useful to have an additional grid of UV light sources 606 positioned downstream of the purification sensor 611, so that additional sanitizing may be performed in the event that the purification sensor 611 indicates that the purity of the air is below a preselected setpoint.

Over time, the effectiveness of the UV light sources 606 may be reduced. Accordingly, it may be useful to employ two or more grids of UV light sources 606 so that the additional grids may be energized as the original grid of UV light sources 606 become less effective. In this manner, the useful life of the air sanitizing system may be extended.

In some embodiments of the instant invention, the effectiveness of the UV light sources 606 may be enhanced by placing a reflective coating or layer 623 around the transparent or translucent section of the pipe 600. In this manner, light emitted from the UV light sources 606 may be reflected back into the interior chamber of the pipe 600 to further enhance the sanitizing effect of the UV light.

Likewise, as can be seen in FIGS. 5B and 5C, the effectiveness of the UV light sources 606 may be enhanced by the use of optics to expand and/or focus the UV light. For example, as shown in FIG. 5C, a microlens array 630 may be positioned adjacent a VCSEL array 632 to focus the UV light emitted by each of the individual VCSELs. Thereafter, an expander 634 and focus lens 636 may be used to create the desired optical pattern of UV light. Additionally, Fresnel lenses may be used in conjunction with the UV light sources 606 to focus the UV light and create greater energy density, and thus, a greater sanitizing effect.

One embodiment of a method that may be employed to manufacture the pipe 600 and the grid of UV light sources 606 is shown in FIGS. 5D-5G. As shown in FIG. 5D, the process begins by forming a generally flat grid 626 of UV light sources 606. In FIG. 5E, the flat grid 626 is rolled into a tube shape, placed in a mold, and cast in a transparent or translucent material, such as an acrylic, to form a sleeve 631. One or more of the sleeves 631 are then slid into a pipe section 640 to form a pipe 600 that is capable of using UV light to sanitize air passing therethrough. FIG. 5F illustrates a pipe 600 in which a single sleeve 631 is disposed therein. FIG. 5G illustrates a pipe in which two sleeves 631 are serially disposed therein.

One process for sanitizing air using the embodiments described in FIGS. 5A-5G is set forth in a flow chart in FIG. 6. The process begins at block 700 with the UV sanitizing system being turned on. At block 705, a valve is opened and air begins flowing through the pipe 600. Signals from the feedback sensors 610, 611 are evaluated by the computer control system 18 at block 710. The computer control system 18 determines whether the UV light energy is at the desired level, and, if not, adjusts the power level supplied by the power supply 605 to the UV light sources 606. At block 715, the computer control system 18 receives signals indicative of the actual flow rate of the air in the pipe 600, and adjusts the setting of a control valve, a fan, air pump, or the like to maintain a desired flow rate. After any adjustment to the parameters of the system, such as power settings or flow rate, the computer control system 18 monitors the energy density and purity to determine if the adjustments have had the desired effect at blocks 720, 725. If not, and the air purity drops below a desired level, an alarm is sounded at block 730 to alert personnel of a problem that requires attention. At block 735, in the event that the system employs two UV grids 631, then the secondary grid may be energized to assist in the sanitizing process.

FIG. 7A depicts a stylized view of a roof region 748 of a mass transit vehicle, such as a bus, airplane or the like. The vehicle employs a ventilation system 752 (see FIG. 7B) to distribute sanitized air throughout the vehicle via a plurality of vents 750. As shown in FIG. 7B, the ventilation system 752 may be comprised of generally rectangular air vents 754 and the generally circular vents 750 coupled to a source of forced air (not shown), such as a fan, via ductwork 756. In the illustrated embodiment, the ductwork 756 is generally circular in cross section and includes a circular sanitizer 758 that employs UV light to sanitize the air flowing therethrough. The circular sanitizer 758 may be of the forms shown and described above in conjunction with FIGS. 1-6.

Likewise, the rectangular air vents 754 are coupled to generally rectangular ductwork 760 that employs a flat panel sanitizer 762 that uses UV light to sanitize the air flowing therethrough. The flat panel sanitizer 750 may be of the forms shown and described below in conjunction with FIGS. 8-11.

FIG. 7C schematically shows an HVAC system 768 employed in a house or commercial building. A heating and cooling unit 770 is located within an attic of the building, which through the use of a fan (not shown) pulls air through return air duct 772, heats or cools the air, as desired, and then directs the conditioned air back into the building via one or more ducts 776. A UV sanitizer 774 is positioned in the return air duct 772 such that all air being pulled from the interior of the building passes therethrough before being conditioned and returned to the building via the vents 776. The UV santizer 774 can take on any of the forms described herein, such as the circular units shown above in FIGS. 1-6 or the flat panel units shown and discussed below in conjunction with FIG. 8-11.

Similarly FIGS. 7D and 7E illustrate a large-scale commercial HVAC system 780 that includes circular santizers 782 located in the ductwork of the HVAC system 780.

FIG. 7F illustrates two types of circular units 790, 795 that may employ UV illumination cast within the sidewalls of the ductwork in a similar manner to that described above in conjunction with FIGS. 5A-5G. The circular unit 790 may be constructed with an outer casing that can be a structural component that needs no additional housing and can form an entire segment of a ventilation system, and in some embodiments may include a flange 796 formed integral therewith at one or more end portions of the circular unit 790 to allow the circular unit 790 to be joined with conventional ductwork. Alternatively, the circular unit 795 may be constructed with an outer housing that is sized to be placed within and surrounded entirely by additional structural ductwork.

Various configurations of the flat panel sanitizers discussed in FIGS. 7B and 7C above are shown and described in FIGS. 8-11. Turning now to FIGS. 8 and 9, an alternative embodiment of the instant invention is illustrated. In this embodiment, a plurality of vertical cavity surface emitting lasers (VCSELs) or vertical light emitting diodes (VLEDs) 800 are employed to deliver UV light within the rectangular ductwork 20. In some embodiments of the instant invention it may be useful to combine the VCSELs and/or VLEDs with Fresnel Lenses. The VCSELs 800 are deployed on inner surfaces of the ductwork 20, such as on the top and side walls 801, 802. The VCSELs 800 may be deployed singularly, or arranged in strips or arrays to provide UV laser light over a substantial portion of the rectangular ductwork 20 with sufficient energy density to provide acceptable levels of sanitization within the rectangular ductwork 20. Additionally, the VCSEL's 800 may be arranged in arrays or panels that are oriented in slightly different directions such that substantial overlapping coverage of the rectangular ductwork 20 is effected, as shown in FIG. 9.

Turning now to FIGS. 10 and 11, an alternative embodiment of the instant invention is illustrated in which Fresnel lenses 802, 804 or micro-lenses are disposed adjacent to various UV light sources. The Fresnel Lenses 802, 804 act to direct the UV light throughout the rectangular ductwork 20 at various angles and directions to provide substantial overlapping coverage. In the illustrated exemplary embodiments, Fresnel lens strips 802 or panels 804 are affixed to or otherwise constructed adjacent the top, back and/or side walls of the cooking chamber 12. The Fresnel lens strips 802 or panels 804 can be illuminated by a variety of UV light sources or methods. In one exemplary embodiment, conventional backlighting of the Fresnel lenses 802, 804 can be achieved by using UV lamps 806 contained in a reflective light fixture or housing located above or behind the Fresnel lenses 802, 804 within the rectangular ductwork 20. Those skilled in the art will appreciate that other UV lighting technology and solutions may be used in the alternative, such as phosphorous light strips (not shown), UV Electro-luminescent tape 808, VCSEL/VLED panels 810, or through backlighting by illumination of a clear substrate, such as acrylic 812 or glass (not shown) with sufficient thickness as to carry greater concentrations of UV light energy pumped in or projected into the substrate from the side by use of UV LED strips 814 or UV laser diode strips.

Each of these various embodiments of the backlit Fresnel lenses 802, 804, may be combined with a reflective mirrored backing 816 with or without the formation of angles on the reflective surface to control the direction of the UV light energy or to cause an increase in the angles of incidence. In addition, the Fresnel lenses 802, 804 may be illuminated by the use of a wafer panel or wafer strip with a plurality of vertical cavity surface emitting lasers combined with a micro lens array (not shown) as produced in a postage-stamp-sized chip containing hundreds of solid state micro-cavity lasers or UV VCSEL lasers, which may be grouped in series or in parallel to form UV laser strips or UV laser panels to project through the Fresnel lenses 802, 804 into the rectangular ductwork 20. The Fresnel lenses 802, 804 may be designed and installed for optimal UV light distribution with either a concentration to increase sanitizing effect or for maximum distribution of the UV light to flood the food rectangular ductwork 20 with UV light energy, to produce a positive or negative focus, and in some instances to produce both positive & negative focus from a single Fresnel lens, as is available through custom manufacturing of the Fresnel lens, to collimate the UV light and to cause divergence of the UV light energy within the rectangular ductwork for substantial efficiency and effectiveness in the sanitizing process.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method for sanitizing air, the method comprising:
exposing air in a ventilation system to ultraviolet laser light.

2. An apparatus for sanitizing air, the apparatus comprising:
an ultraviolet laser light source; and
means for transmitting UV light from the ultraviolet laser light source through the air.

3. An apparatus, comprising:
ductwork for conveying air;
at least one laser for generating ultraviolet laser light, wherein the ultraviolet laser light has at least one of a frequency or intensity sufficient to sanitize air; and
at least one optical element for distributing the ultraviolet laser light within the ductwork to sanitize air in the ductwork.

4. The apparatus of claim 3, wherein said at least one laser comprises a plurality of lasers, and wherein said at least one optical element comprises mechanical or optical elements for distributing ultraviolet laser light generated by the plurality of lasers within the ductwork.

5. The apparatus of claim 4, wherein at least two of the lasers generate ultraviolet laser light in different frequency ranges or at differeht intensities.

6. The apparatus of claim 3, comprising a computer control system for controlling at least one of said at least one laser or said at least one optical element to sanitize air in the ductwork.

7. The apparatus of claim 6, wherein the computer control system is configurable to vary at least one of a signal indicating that said at least one laser is to raise or lower an intensity of the ultraviolet laser light or a signal indicating that a flow rate of air in the ductwork is to be modified based on a detected ultraviolet power.

8. The apparatus of claim 6, comprising an irradiance monitor that detects ultraviolet laser light energy and provides feedback to the computer control system, and wherein the computer control system is configurable to vary properties of the laser based on the feedback.

9. The apparatus of claim 3, wherein said at least one optical clenient comprises at least one optical device for producing at least one beam of ultraviolet laser light extending along a line generally longitudinally aligned with the ductwork in at least one of an upstream or downstreain direction.

10. The apparatus of claim 3, wherein the ductwork is coated with or formed from a reflective or refractive material.

11. The apparatus of claim 3, wherein the ductwork comprises a plurality of curved or bent sections to produce a linear region that is offset from a main path of the ductwork, and wherein said at least one optical element is configurable to introduce ultraviolet laser light into the linear region.

12. The apparatus of claim 3, wherein said at least one laser comprises a plurality of lasers arranged in a grid or matrix within the ductwork.

13. An apparatus, comprising:
ductwork for conveying air;
at least one ultraviolet light source for generating ultraviolet light, wherein the ultraviolet light has at least one of a frequency or intensity sufficient to sanitize air; and
a plurality of optical elements for distributing the ultraviolet light within the ductwork to sanitize air in the ductwork, wherein the plurality of optical elements comprises a micro lens array or a plurality of Fresnel lenses.

14. The apparatus of claim 13, wherein said at least one ultraviolet light source comprises at least one of a Vertical Light Emitting Diode (VLED), a Vertical Cavity Surface Emitting Laser (VCSEL), an Edge Emitting Laser (EEL), a plasma device, or a phosphor device.

15. An apparatus, comprising:
ductwork for conveying air;
a grid comprising a plurality of ultraviolet light sources for generating ultraviolet light; wherein the ultraviolet light has at least one of a frequency or intensity sufficient to sanitize air, and wherein the grid is deployed within the ductwork; and
a plurality of optical elements for distributing the ultraviolet light within the ductwork to sanitize air in the ductwork.

16. The apparatus of claim 15, wherein the grid comprises a flat grid that has been rolled into a tube shape to form a sleeve that is deployed within the ductwork.

17. The apparatus of claim 16, wherein the sleeve comprises a transparent or translucent material.

18. The apparatus of claim 15, wherein the plurality of ultraviolet light sources comprises at least one of “a Vertical Light Emitting Diode (VLED), a Vertical Cavity Surface Emitting Laser (VCSEL), an Edge Emitting Laser (EEL), a plasma device, or a phosphor device.
